(19) United States
(12) Patent Application Publication
(10) Pub. No.: US 2026/0173112 A1
(43) Pub. Date: Jun. 18, 2026

(54) USER EQUIPMENT AND METHOD OF SIGNAL RECEPTION AND RESOURCE ALLOCATION IN SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/532,250

(22) Filed: Feb. 6, 2026

Related U.S. Application Data
(63) Continuation of application No. PCT/CN2024/126557, filed on Oct. 22, 2024.
(60) Provisional application No. 63/546,679, filed on Oct. 31, 2023.

(51) Int. Cl. H04W 72/25; H04W 28/26; H04W 76/14

(52) U.S. Cl. CPC H04W 72/25; H04W 28/26; H04W 76/14

(57) ABSTRACT

A method of signal reception and resource allocation in sidelink communication by a user equipment (UE) includes providing one or more assistance information to a peer UE in a sidelink unicast communication link, and determining a timing/slot and/or a duration and a type of receive beam to use for a sidelink reception in a sidelink resource pool, and/or indicating the peer UE for determination of another timing/slot and/or another duration and another type of receive beam to use for the sidelink reception in the sidelink resource pool.

### CROSS-REFERENCE TO RELATED APPLICATION

This application is a Continuation Application of International Application No. PCT/CN2024/126557 filed on Oct. 22, 2024, which claims priority to U.S. Provisional Patent Application No. 63/546,679, filed on Oct. 31, 2023. The above-referenced applications are incorporated herein by reference in their entirety.

### BACKGROUND OF DISCLOSURE

### 1. Field of the Disclosure

The present disclosure relates to the field of communication systems, and more particularly, to a user equipment (UE) and a method of a signal reception and resource allocation in sidelink communication, which can provide a good communication performance and/or provide high reliability.

### 2. Description of the Related Art

In the advancement of radio wireless transmission and reception directly between two devices, which is often known as device-to-device (D2D) communication, it was first developed and introduced by 3rd generation partnership project (3GPP) in Release 12 (officially specified as sidelink communication) and later improved in Release 13 for Public Safety emergency usage such as mission critical communication to support mainly low data rate and voice type of connection. In 3GPP Release 14, 15 and 16, the sidelink technology was advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology was further enhanced in Release 17 in the area of device power saving and transceiver link reliability. In Release 18, 3GPP further evolved the wireless technology and expand its operation into unlicensed frequency spectrum for larger available bandwidth, faster data transfer rate and easier market adoption of D2D communication using sidelink without requiring any mobile cellular operator's involvement to allocate and configure a part of their expansive precious radio spectrum for data services that do not go throughput their mobile networks.

Therefore, there is a need for a user equipment (UE) and a method of a signal reception and resource allocation in sidelink communication, which can solve issues in the prior art and other issues.

### SUMMARY

In a first aspect of the present disclosure, a method of signal reception and resource allocation in sidelink communication by a user equipment (UE), includes providing one or more assistance information to a peer UE in a sidelink unicast communication link, and determining a timing/slot and/or a duration and a type of receive beam to use for a sidelink reception in a sidelink resource pool, and/or indicating the peer UE for determination of another timing/slot and/or another duration and another type of receive beam to use for the sidelink reception in the sidelink resource pool.

In a second aspect of the present disclosure, a user equipment (UE) includes a provider and a determiner and/or an indicator. The provider is configured to provide one or more assistance information to a peer UE in a sidelink unicast communication link, and the determiner is configured to determine a timing/slot and/or a duration and a type of receive beam to use for a sidelink reception in a sidelink resource pool, and/or the indicator is configured to indicate the peer UE for determination of another timing/slot and/or another duration and another type of receive beam to use for the sidelink reception in the sidelink resource pool.

In a third aspect of the present disclosure, a user equipment (UE) includes a memory, a transceiver, and a processor coupled to the memory and the transceiver. The UE is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a non-transitory computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure or related art more clearly, the following figures may be described in the embodiments are briefly introduced. It is obvious that the drawings are merely some embodiments of the present disclosure, a person having ordinary skill in this field can obtain other figures according to these figures.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method signal reception and resource allocation in sidelink communication according to an embodiment of the present disclosure.

FIG. 5 is a schematic diagram illustrating a transmission (TX) and reception (RX) beamforming for sidelink (SL) broadcast, groupcast and unicast communications according to an embodiment of the present disclosure.

FIG. 6 is a schematic diagram illustrating a proposed method of signal reception using RX beamforming for unicast communication and resource allocation to avoid unicast reception according to an embodiment of the present disclosure.

FIG. 7 is a block diagram of a UE for wireless communication according to an embodiment of the present disclosure.

FIG. 8 is a block diagram of an example of a computing device according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. The terminologies in the embodiments of the present disclosure are merely for describing the purpose of the certain embodiment, but not to limit the disclosure.

Device-to-device (D2D) communication, developed by the 3rd Generation Partnership Project (3GPP) in Release 12, was introduced as sidelink communication and initially focused on low data rate and voice connections for public safety use. Later, in Releases 14 to 16, sidelink technology evolved to support vehicle-to-everything (V2X) communication, enhancing road safety and enabling autonomous driving. Release 17 further improved power efficiency and link reliability for devices with limited battery. In Release 18, 3GPP expanded D2D communication into the unlicensed frequency spectrum, allowing faster data transfer without requiring mobile operators'involvement. Since 3GPP Release 16, the sidelink technology has been developed based on the latest 5th generation (5G) new radio (NR) access system including the support of frequency range 1 (FR 1 ) bands (410 MHz to 7125 MHz), frequency range 2 (FR2) bands (24250 MHz to 71000 MHz) and various OFDM transmission numerologies/sub-carrier spacings (SCSs) (15k, 30k, 60 k and 120k Hz). One of the main motivations to support additional spectrum bands compared to the 4G long term evolution (LTE) system (i.e., FR2) is the availability of large spectral bandwidth to support high data rate applications and the use of various SCSs to allow very low latency radio transmissions for delay sensitive services. However, the main drawbacks of radio transmission in high frequency bands (i.e., in FR2) are the high attenuation in signal strength over distance from the transmitter (high pathloss) and the communication system is prone to frequency/phase errors due to the short wavelengths. For the NR sidelink system, it is claimed to support FR2 spectrum bands by introducing a phase tracking reference signal (PT-RS) in Release 16. However, no particular enhancement or advanced feature has been supported in NR sidelink to combat/mitigate the high pathloss issue in FR2.

Transmit beamforming and sweeping in downlink:
Over the downlink (DL) and uplink (UL) of the Uu interface, the concept/feature of transmit beamforming and beam management has been developed and introduced since the beginning of the 5G-NR system in Release 15 to improve received signal strength, enhance cellular DL and UL coverages and minimize radio interference to neighbor cells. In order to enable the transmit beamforming/beam management feature over the Uu interface, particularly in the DL, the concept of beam sweeping is introduced by forming a transmit beam and sweeping it across all the directions in space (both horizontal and vertical spatial domains) that the base station (gNB) supports. Once a user equipment (UE) has received all the transmit beams or as many as it could (according to a pre-defined pattern and time interval), the UE selects a best beam and sends a physical random-access channel (PRACH) to the gNB in a RACH occasion that corresponds to the selected best beam. At the base station, gNB determines the selected best beam from the UE according to the received RACH occasion and uses the selected best beam to complete the random-access procedure in order for the UE to connect to the base station. The same selected best beam may be also used for the subsequent data communication between the gNB and the UE until the selected best beam is further updated/switched (e.g., due movement of the UE).

Necessity of transmit beamforming and beam management in sidelink:
As mentioned previously, radio communication in high frequency spectrum (i.e., FR2 bands) may suffer from large attenuation in the transmitted signals and propagation loss through the space compared to the lower frequency bands that the cellular system traditionally operates. Besides the PT-RS that can be used by sidelink communicating devices to correct phase errors in the received carrier frequency in FR2 and the maximum device transmit power is limited by a device's power class definition, there is currently no other way to improve the communication range/signal coverage, unless the transmit beamforming and beam management features are also supported for the NR sidelink technology. By improving the signal coverage/communication range for sidelink, it may enable a few new use cases and applications for the users and mobile operators, such as enhancing the network coverage from sidelink relaying on a FR2 carrier and offloading network traffic onto a sidelink FR2 carrier for two UEs that are within the same cell.

Channel sensing and reservation in sidelink resource allocation:
In 3GPP developed sidelink technology for D2D communication, transmission resources often need to be selected by the UE itself as the network serving basestation is unlikely to have any knowledge of the radio resource usage that is experienced/seen at the UE. Or simply the UE is operating sidelink out of the coverage of any network. To enable a such operation, a UE autonomous resource allocation mode (i.e., Mode 2) is supported in NR sidelink communication. When a sidelink UE operates in Mode 2 resource allocation (RA), the UE is required to perform channel sensing over a time period and decode all received sidelink control information (SCI) that contains reservation information of radio resources from other UEs. Then based on the resource reservation information obtained from channel sensing, the sidelink UE would be able to determine the remaining radio resources that are available for selection and transmission of sidelink data. However, if the beamforming feature is to be introduced in sidelink communication, the beam direction in which the channel sensing can be performed remains unclear and it would have a significant impact to the results of the channel sensing, the obtained resource reservation information and to the reception performance of sidelink data.

In some embodiments, in the present proposed signal reception method for sidelink communication (e.g., in FR2 spectrum), a UE in a sidelink unicast communication indicates the sidelink resources and/or timing (e.g., slots) in which it intends to perform sidelink transmission to the other UE in the unicast such that the other UE is able to apply receive beamforming at a right timing and in an appropriate direction for channel sensing, data decoding and subsequently for resource allocation as well. Other benefits from adopting the proposed assisted receive beamforming and resource indication methods in sidelink communication may also include: Improved reception of sidelink broadcast and groupcast data in slots and spatial directions that are not covered by the dedicated receive beam used in unicast. Improved channel sensing results and outcome that includes sidelink resources reserved by UEs other than the sidelink unicast communication. Proximity D2D discovery messages transmitted via sidelink broadcast from other UEs can be received.

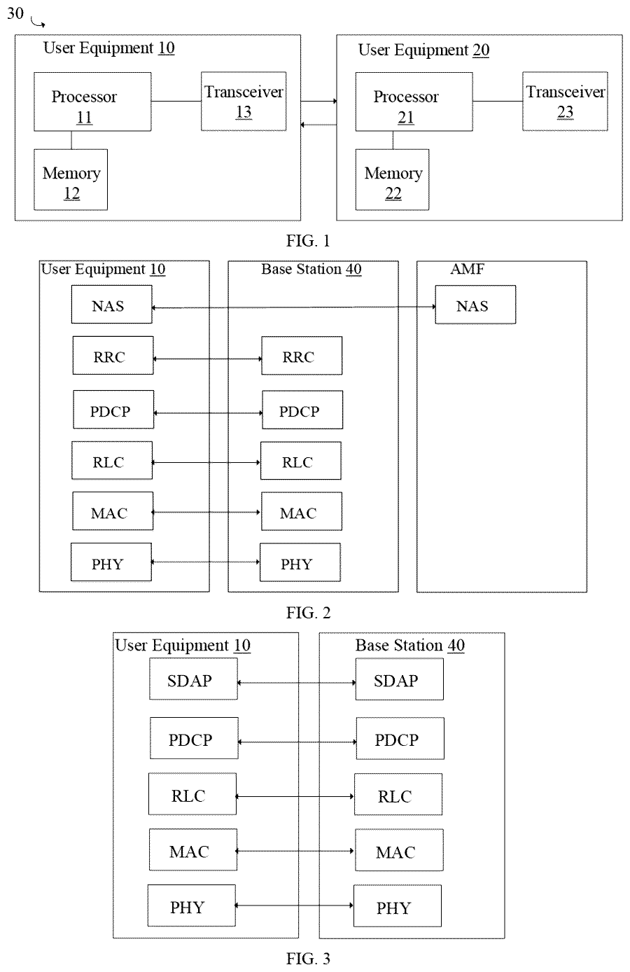

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 19 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L 1 ) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. Alternatively, the application-related information is received from the network to be provided from the AS (RRC) layer to the application layer, and when the application layer starts the data communication service, the application layer requests the information provision to the AS (RRC) layer to receive the information.

In some embodiments, the processor 11 is configured to provide one or more assistance information to a peer UE in a sidelink unicast communication link and determine a timing/slot and/or a duration and a type of receive beam to use for a sidelink reception in a sidelink resource pool, and/or the processor 11 is configured to indicate the peer UE for determination of another timing/slot and/or another duration and another type of receive beam to use for the sidelink reception in the sidelink resource pool. This can solve issues in the prior art and other issues and/or improve SL communication performance and reliability.

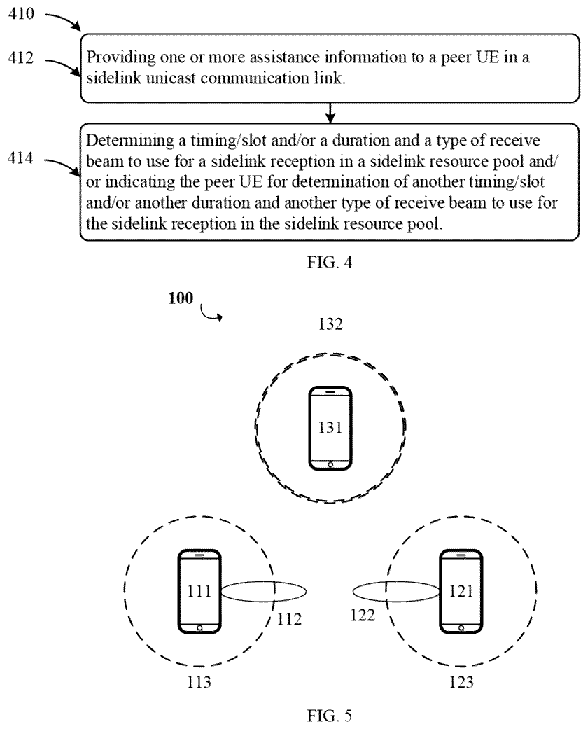

FIG. 4 illustrates a method of signal reception and resource allocation 410 in sidelink communication between user equipments (UEs) according to an embodiment of the present disclosure. In some embodiments, the method of signal reception and resource allocation 410 includes: an operation 412, providing one or more assistance information to a peer UE in a sidelink unicast communication link, and an operation 414, determining a timing/slot and/or a duration and a type of receive beam to use for a sidelink reception in a sidelink resource pool and/or indicating the peer UE for determination of another timing/slot and/or another duration and another type of receive beam to use for the sidelink reception in the sidelink resource pool. This can solve issues in the prior art and other issues and/or improve SL communication performance and reliability.

In some embodiments, the UE in the sidelink unicast communication link is configured to indicate or configure the peer UE the timing/slot and/or the duration associated with a discontinued reception time in which the UE does not expect to receive a sidelink unicast transmission from the peer UE. In some embodiments, by providing the one or more assistance information to the peer UE, the UE is not be required to apply a directional receive beam and/or beamforming associated with the sidelink unicast communication link during the discontinued reception time. In some embodiments, the one or more assistance information is transmitted as a part of sidelink control information (SCI) channel encoded in a physical sidelink control channel (PSCCH) and/or a physical sidelink shared channel (PSSCH). In some embodiments, the one or more assistance information is signaled by the UE to the peer UE via a PC5-radio resource configuration (RRC) information and/or a medium access control-control element (MAC-CE) information. In some embodiments, the one or more assistance information includes at least one of following information: a starting and/or a slot offset from a reference time or slot, wherein the starting and/or the slot offset is a slot in which the assistance information is transmitted or an offset to a sidelink system frame number (SFN), a duration timer used to indicate a time length for a sidelink suspended/discontinued reception, a source identifier (ID) and/or a destination ID used to identify the SL unicast communication link for which the sidelink suspended/discontinued reception applies, or a cast type indicator used to indicate a unicast.

In some embodiments, the one or more assistance information indicated in a SCI is used for sidelink unicast reception with a receive beamforming by the peer UE. In some embodiments, by providing the one or more assistance information to the peer UE, the peer UE is not be required to apply a directional receive beam and/or beamforming associated with the sidelink unicast communication link other than the another timing/slot and/or the another duration. In some embodiments, the one or more assistance information includes at least one of following information: a time resource assignment for one transport block (TB) and/or a hybrid automatic repeat request (HARQ) process number, an additional time resource assignment for another TB and/or another HARQ process number, one or more HARQ process numbers for one or more TBs, one or more resource reservation periods for one or more TBs and/or one or more HARQ process numbers, a source ID and/or a destination ID used to identify the sidelink unicast communication link for which a sidelink suspended/discontinued reception applies, or a cast type indicator used to indicate a unicast. In some embodiments, the method further includes requesting the peer UE during a UE autonomous resource allocation procedure to exclude candidate resources based on a discontinued reception time provided in the one or more assistance information when the UE is not expected to receive a sidelink unicast transmission. In some embodiments, the method further includes requesting the peer UE during a UE autonomous resource allocation procedure to exclude candidate resources based on the time resource assignments, the one or more resource reservation periods and/or a timing/slot indicated in the SCI for the sidelink unicast transmission by the UE.

In some embodiments, the term “/” can be interpreted to indicate “and/or.” The term “configured” can refer to “pre-configured” and “network configured”. The term “preset”, “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “preset” and “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### EXAMPLES

In some embodiments of the present disclosure, a new inventive method for user equipment (UE) reception of sidelink (SL) reference signals and channels for channel sensing, data decoding and resource allocation using receive (RX) beamforming, the timings or slots in which the UE performs RX beamforming for the sidelink reception is determined in accordance to an assisted information (which could be a resource reservation and/or resource indication) from at least one other UE to maximize the UE reception of sidelink control and data information from the surrounding UES without sacrificing reception performance of a SL unicast communication.

For the usage of a transmit (TX) beamforming in sidelink, as described earlier, the radiated transmission power of a radio wave is focus on one particular horizontal and/or vertical spatial direction, ideally towards the intended target communicating UE, to enhance the radio signal energy arrived at the receiver (after the propagation loss over the space). This special radio transmission technique is commonly known as TX beamforming in the 5th generation new radio (5G NR) mobile communication system, and typically used by a gNB base station to boost the power of data transmission towards its serving UEs. And thus, the decoding performance at the receiver UE can be improved. Similarly, a RX beamforming can be also applied at the UE to further enhance the signal reception power for the decoder by adjusting the spatial direction in which the receiver antenna gain can be applied.

In SL unicast communication wherein one UE directly communicates and exchange data with another UE, in order to maximize the communication performance and coverage in both transmission and reception directions, it would be best to deploy a TX beamforming and as well as a RX beamforming by both UEs. However, as described previously radio resources for SL transmission are selected autonomously (in both time and frequency domains) by each UE. Without any prior indication or reservation of resources from a transmitter UE, the other UE (receiver) will need to blindly monitor the channel and apply a RX beamforming all the time to decode sidelink control information (SCI) that schedules the resource(s) for data transmission. Besides the data reception in SL unicast, this blind decoding process (channel sensing) and results can be also used for selection/allocation of transmission resources by the receiver UE if it intends to later perform a SL transmission to the other UE. When a RX beamforming is used in the channel sensing process, it improves reception of SCI/reservations in the direction of the other UE to reduce a hidden node problem, which is always a source of interference in sidelink communication. Since RX beamforming is only able to focus its reception in one particular direction at a time, it will also lead to detection of less reservation of resources, and as such, more candidate resources for transmission.

In SL communication, a UE may be communicating with and need to receive data from more than one UE at the same time (e.g., for SL broadcast and groupcast communication). If the RX beamforming is employed at all time for a SL unicast, then the UE risks of not being able to receive SL transmissions from others (i.e., SL broadcast, groupcast and other unicast links). And since resource reservations from SL broadcast, groupcast and other unicasts cannot be received, this increases the collision probability of selecting the same resources with those UEs. On the other hand, if no RX beamforming is applied in channel sensing, then the SL unicast performance will be degraded.

In reference to diagram 100 in FIG. 5, let's first assume a simple SL communication system includes of three UEs (without any involvement of a network base station, gNB), namely UE1 (111), UE2 (121) and UE3 (131), where UE1 (111) and UE2 (121) are engaging in a SL unicast communication with each other, and UE3 (131) transmits and receives only broadcast SL data messages. Let's further assume that through a SL beam management process, UE1 (111) and UE2 (121) have each identified/established a pair of unicast TX/RX beams 112 and 122 that point towards each other for the best SL unicast communication performance between them. Besides the TX and RX beamforming capabilities that are supported by both UEs, the said UE1 (111) and UE2 (121) support also no beamforming operation for SL reception with omni directional RX beams 113 and 123, respectively. It should be noted that when omni directional RX beam is used for receiving signals from all directions, the receive coverage/distance (i.e., the RX antenna gain) can be significantly less compared to the case when a directional RX beamforming is employed, as shown by beams 112 and 113, and beams 122 and 123. Hence, it is ideal that a RX beam is always used for reception of SL data from a particular direction (i.e., pointing directly towards the transmitter UE). For UE3 (131), since it is not engaged in a SL unicast communication with either UE1 or UE2, and transmits/receives only broadcast data messages to/from UE1 and UE2, the UE3 (131) employs omni directional TX and RX beams 132.

Proposed method of assisted RX beamforming for SL reception:
In order to maximize SL data reception in all SL communication cast types for a first UE, it is proposed for a second UE in a SL unicast communication/connection with the said first UE (a peer UE) to provide assistance information so that the second UE is able to determine the timing/duration and the type of RX beam to use for the SL reception (which includes channel sensing and SL data reception) in a SL resource pool, and/or the first UE is able to determine the timing/slot and the type of RX beam to use for the SL reception (which includes channel sensing and SL data reception) in a SL resource pool.

There are two different purposes and methods in which the assistance information can be provided by the second UE to the first UE in a SL unicast communication.

Example method 1 (assistance information for no SL unicast reception and no RX beamforming):
In example method 1, the second UE of a SL unicast connection/communication link is to indicate or configure the peer UE (i.e., the first UE) the timing and/or duration in which the second UE does not expect to receive (e.g., suspended/discontinued reception) SL unicast transmission from the said first UE. By providing a such assistance information to the peer/first UE, the second UE would not be required/need to apply a directional RX beam/beamforming associated with the SL unicast connection/communication link during the discontinued reception time. Instead, the second UE is then able to/can apply an omni direction RX beam for SL reception in all directions within the indicated/configured discontinued reception duration to maximize its SL reception for both channel sensing (for resource allocation) and other SL broadcast and groupcast data messages.

Equivalently, during the non-discontinued reception time for the SL unicast connection/communication link, since the first UE may not transmit SL unicast data messages all the time (e.g., in every slot), the second UE could further use the example method 2 (assistance information provided by the first UE) described in the present disclosure to further determine the timing/slot in which the second UE can apply an associated directional RX beam/beamforming for reception of SL data messages from the first UE.

The assistance information to be provided by a UE to its peer UE in a SL unicast connection/communication link for indicating its SL suspended/discontinued reception time could be transmitted as part of sidelink control information (SCI) channel encoded in physical sidelink control channel (PSCCH) and/or physical sidelink shared channel (PSSCH). Alternatively, the assistance information could be configured by the UE to its peer UE via a PC5-radio resource configuration (RRC) signaling or provided in medium access control-control element (MAC-CE) or a combination of the signaling methods.

In reference to diagram 100 in FIG. 5, as an exemplary illustration of the proposed signal reception mechanism in a SL unicast communication, when UE2 (121) provides an assistance information that indicates/configures a SL suspended/discontinued reception time period that the UE2 (121) does not expect to receive SL transmission from the peer UE1 (111) for the same unicast connection/communication link, the said UE2 (121) applies an omni direction RX beam 123 during the time period for receiving broadcast transmission from UE3 (131). Instead of using the unicast RX beam 122 during the time period indicated/configured by the assistance information.

The assistance information includes one or more of the following pieces of information in order for the peer UE to determine the start and time length (active/ON duration) of the SL suspended/discontinued reception:
“Starting/slot offset” from a reference time or slot, which could be a slot in which the assistance information is transmitted or offset to a SL system frame number (SFN).
“Duration timer” indicating a time length for the intended SL suspended/discontinued reception.
“Source ID and/or destination ID” to identify the SL unicast connection/communication link for which the SL suspended/discontinued reception applies.
“Cast type indicator”: this can indicate a unicast.

Example method 2 (assistance information for SL unicast reception with RX beamforming):
In example method 2, a UE (e.g., a second UE) indicates in SCI a resource assignment and/or a timing/slot in which the UE reserves or intends to perform a PSCCH/PSSCH transmission within a resource pool to its peer UE (e.g., a first UE) in a unicast connection/communication link. The main purpose of indicating a resource assignment and/or a timing/slot of an intended unicast PSCCH/PSSCH transmission in SCI is for the peer UE to apply a RX beam/beamforming associated with the unicast connection/communication link, such that the performance of SL reception/data decoding is enhanced at the peer UE. When the said peer UE has the knowledge/information of the resource and/or timing/slot for which an associated RX beam/beamforming can be applied, it then does not need to apply the same associated RX beam/beamforming for reception of other broadcast, groupcast and unicast transmissions in other resources and timings/slots. Instead, the peer UE can apply no RX beam/beamforming to maximize the reception of SL broadcast and groupcast data messages and channel sensing in the resource pool (and subsequently for resource allocation), or applies a different RX beam/beamforming for another unicast connection/communication link that the peer UE may be also involved with.

The indication of the assistance information in SCI from a UE in a unicast connection/communication link includes one or more of the following pieces of information:
“Time resource assignment” for one transport block (TB)/hybrid automatic repeat request (HARQ) process number.
“Additional time resource assignment” for another TB/HARQ process number.
One of more “HARQ process numbers” for one or more TBs.
One or more “Resource reservation periods” for one or more TBs/HARQ process numbers.
“Source ID and/or destination ID” to identify the SL unicast connection/communication link for which the SL suspended/discontinued reception applies.
“Cast type indicator”: this can indicate a unicast.

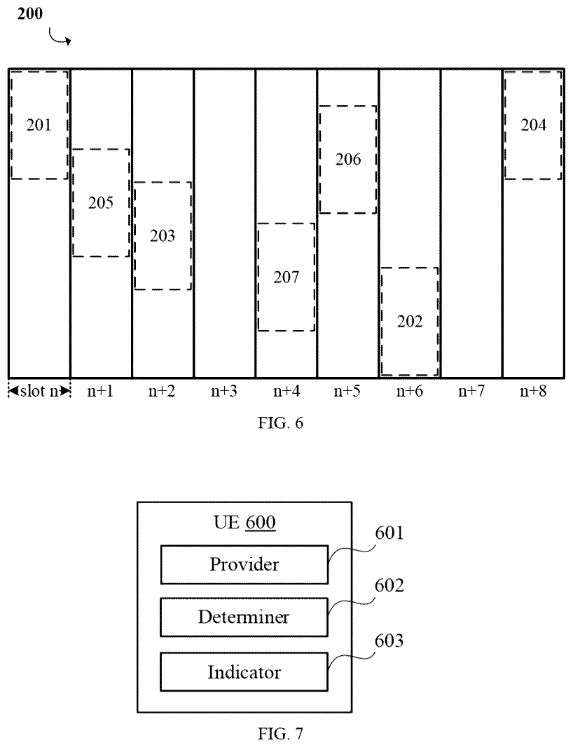

In reference to diagram 200 in FIG. 6, let's firstly denote the same SL communication scenario illustrated in diagram 100 in FIG. 5, wherein UE1 (111) and UE2 (121) are engaged in a SL unicast communication with each other and UE3 (131) transmit only broadcast data messages. Let's further denote slot n, slot n+1 to slot n+8 belong to a same resource pool, and the said UE2 (121) has selected a SL resource 201 in slot n and a SL resource 202 in slot n+6 for transmitting a sidelink TB1 to the said UE1 (111). Additionally, the said UE2 (121) has also selected a SL resource 203 in slot n+2 and a SL resource 204 in slot n+8 for transmitting another sidelink TB2 also intended for the same UE1 (111). In order to maximize the SL reception performance for UE1 (111) in receiving both TB1 and TB2, the said UE2 transmits in SCI an assistance information to UE1 (111) containing the timings/slots of slot n and n+6 for SL unicast TB1, and slot n+2 and n+8 for SL unicast TB2. Then based on the provided assistance information from UE2 (121), the said UE1 (111) applies the associated unicast RX beam 112 in these 4 slots for receiving both TBs from UE2 (121). In all other slots within the resource pool, UE1 (111) can use the omni direction RX beam 113 to receive other sidelink transmissions (e.g., the broadcast transmissions 206 from UE3 (131), except in slot n+4 where the said UE1 (111) has selected a resource 207 for its own SL transmission.

It should be noted that the assistance information described in example Method 1 and example Method 2 can be both provided or individually provided from either one UE to the other UE in a SL unicast connection/communication link to improve SL performance. Ideally, both types of assistance information can be provided by both UEs in a SL unicast connection/communication link for the best performance.

Proposed method for resource allocation based on assistance information:
Based on the described/proposed method in the present disclosure for SL data reception using one or more provided assistance information in SCI, PC5-RRC and/or MAC-CE, a SL unicast UE is able to determine which RX beams (a unicast RX beam or an omni-directional beam) can be applied and the time duration/slots in which the determined RX beam can be used. Besides the SL signal reception that makes use of the assistance information, the said proposed assistance information can be also utilized by a SL transmitting UE during a SL Mode 2 resource selection/allocation procedure.

Since the proposed assistance information provides a time period and timings/slots related to SL reception and transmission in a unicast connection/communication link, it is further proposed in the present closure for a SL transmitting UE during a UE autonomous resource allocation procedure (SL Mode 2) to exclude candidate resources based on a SL discontinued reception time period provided in the assistance information by another UE, since the another UE is not expected to receive a sidelink unicast transmission, and exclude candidate resources based on the resource assignment and/or the timing/slot indicated in SCI for a SL unicast transmission by another UE; otherwise, a half-duplex problem occurs when two unicast UEs are transmitting in a same slot.

FIG. 7 illustrates a UE 600 for wireless communication according to an embodiment of the present disclosure. The UE 600 includes a provider 601 and a determiner 602 and/or an indicator 603. The provider 601 is configured to provide one or more assistance information to a peer UE in a sidelink unicast communication link, the determiner 602 is configured to determine a timing/slot and/or a duration and a type of receive beam to use for a sidelink reception in a sidelink resource pool, and/or the indicator 603 is configured to indicate the peer UE for determination of another timing/slot and/or another duration and another type of receive beam to use for the sidelink reception in the sidelink resource pool. This can solve issues in the prior art and other issues and/or improve SL communication performance and reliability.

In some embodiments, the UE 600 in the sidelink unicast communication link is configured to indicate or configure the peer UE the timing/slot and/or the duration associated with a discontinued reception time in which the UE 600 does not expect to receive a sidelink unicast transmission from the peer UE. In some embodiments, by providing the one or more assistance information to the peer UE, the UE 600 is not be required to apply a directional receive beam and/or beamforming associated with the sidelink unicast communication link during the discontinued reception time. In some embodiments, the one or more assistance information is transmitted as a part of sidelink control information (SCI) channel encoded in a physical sidelink control channel (PSCCH) and/or a physical sidelink shared channel (PSSCH). In some embodiments, the one or more assistance information is signaled by the UE 600 to the peer UE via a PC5-radio resource configuration (RRC) information and/or a medium access control-control element (MAC-CE) information. In some embodiments, the one or more assistance information includes at least one of following information: a starting and/or a slot offset from a reference time or slot, wherein the starting and/or the slot offset is a slot in which the assistance information is transmitted or an offset to a sidelink system frame number (SFN), a duration timer used to indicate a time length for a sidelink suspended/discontinued reception, a source identifier (ID) and/or a destination ID used to identify the SL unicast communication link for which the sidelink suspended/discontinued reception applies, or a cast type indicator used to indicate a unicast.

In some embodiments, the one or more assistance information indicated in a SCI is used for sidelink unicast reception with a receive beamforming by the peer UE. In some embodiments, by providing the one or more assistance information to the peer UE, the peer UE is not be required to apply a directional receive beam and/or beamforming associated with the sidelink unicast communication link other than the another timing/slot and/or the another duration. In some embodiments, the one or more assistance information includes at least one of following information: a time resource assignment for one transport block (TB) and/or a hybrid automatic repeat request (HARQ) process number, an additional time resource assignment for another TB and/or another HARQ process number, one or more HARQ process numbers for one or more TBs, one or more resource reservation periods for one or more TBs and/or one or more HARQ process numbers, a source ID and/or a destination ID used to identify the sidelink unicast communication link for which a sidelink suspended/discontinued reception applies, or a cast type indicator used to indicate a unicast. In some embodiments, the indicator is configured to indicate the peer UE during a UE autonomous resource allocation procedure to exclude candidate resources based on a discontinued reception time provided in the one or more assistance information when the UE is not expected to receive a sidelink unicast transmission. In some embodiments, the indicator is configured to indicate the peer UE during a UE autonomous resource allocation procedure to exclude candidate resources based on the time resource assignments, the one or more resource reservation periods and/or a timing/slot indicated in the SCI for the sidelink unicast transmission by the UE.

In some embodiments, in a sidelink broadcast communication or a sidelink groupcast communication, a reception capability of the first UE, a RF tuning/retuning time required at the first UE, and/or a transmission capability of the first UE is same as the reception capability of the second UE, the RF tuning/retuning time required at the second UE, and/or the transmission capability of the second UE, respectively. In some embodiments, in a sidelink broadcast communication or a sidelink groupcast communication, a reception capability of the first UE, a RF tuning/retuning time required at the first UE, a transmission capability of the first UE, the reception capability of the second UE, the RF tuning/retuning time required at the second UE, and/or the transmission capability of the second UE is based on a network configuration or a pre-configuration of a minimum value.

In some embodiments, the term “/” can be interpreted to indicate “and/or.” The term “configured” can refer to “pre-configured” and “network configured”. The term “preset”, “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “preset” and “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

In summary, to optimize sidelink (SL) data reception for a first UE in all communication types, it is proposed that a second UE in a unicast connection with the first UE provides assistance information. This allows either the second UE to determine the timing, duration, and RX beam type for SL reception, or the first UE to do so within the SL resource pool. Two methods are suggested: In Method 1, the second UE informs the first UE when it will not receive SL transmissions, eliminating the need for beamforming during that time. This information can be provided via sidelink control information (SCI), radio resource configuration (RRC), or medium access control (MAC) signaling and should include details like start time, duration, and connection identifiers. In Method 2, the second UE provides resource and timing assignments for transmissions to the first UE, including resource assignments, HARQ process numbers, and unicast connection identifiers. Ideally, both methods are used to enhance performance. Additionally, during resource allocation, UEs should exclude resources based on the provided assistance information to avoid conflicts, such as half-duplex issues when two UEs transmit in the same slot.

Commercial interests for some embodiments are as follows. 1. Solving issues in the prior art and other issues. 2. Improving a sidelink (SL) communication performance. 3. Improve accuracy of receive beamforming, thereby enhancing efficiency of channel sensing and data decoding, while also optimizing precision of resource allocation. 4. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, 19, and beyond for providing direct device-to-device (D2D) wireless communication services.

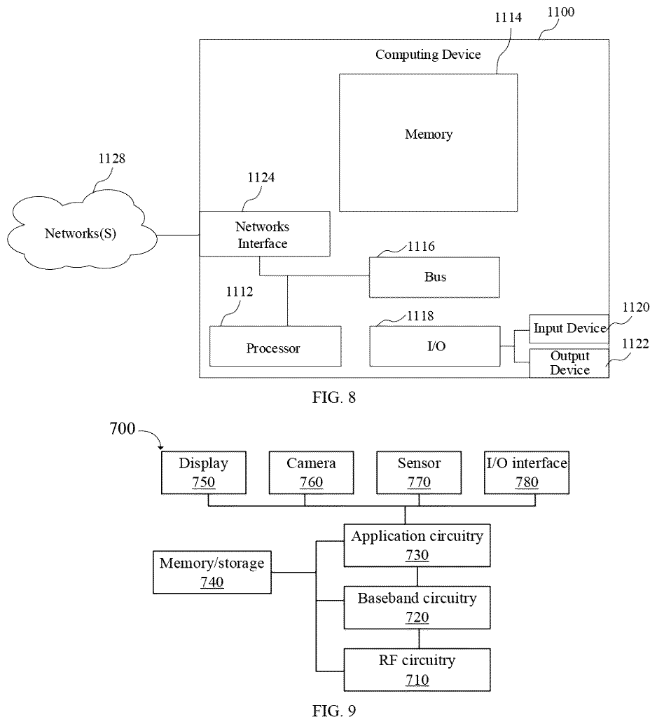

FIG. 8 is a block diagram of an example of a computing device according to an embodiment of the present disclosure. Any suitable computing device can be used for performing the operations described herein. For example, FIG. 8 illustrates an example of the computing device 1100 that can implement some embodiments in FIG. 1 to FIG. 7, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a non-transitory computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 7. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes may not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a non-transitory readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a non-transitory storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with the exemplary embodiments, it is understood that the present disclosure is not limited to the disclosed embodiments but is intended to cover various arrangements made without departing from the scope of the broadest interpretation of the appended claims.

What is claimed is:

1. A method of signal reception and resource allocation in sidelink communication by a user equipment (UE), comprising:
providing one or more assistance information to a peer UE in a sidelink unicast communication link; and
determining a timing/slot and/or a duration and a type of receive beam to use for a sidelink reception in a sidelink resource pool; and/or indicating the peer UE for determination of another timing/slot and/or another duration and another type of receive beam to use for the sidelink reception in the sidelink resource pool.

2. The method of claim 1, wherein the UE in the sidelink unicast communication link is configured to indicate or configure the peer UE the timing/slot and/or the duration associated with a discontinued reception time in which the UE does not expect to receive a sidelink unicast transmission from the peer UE.

3. The method of claim 1, wherein by providing the one or more assistance information to the peer UE, the UE is not be required to apply a directional receive beam and/or beamforming associated with the sidelink unicast communication link during the discontinued reception time.

4. The method of claim 1, wherein the one or more assistance information is transmitted as a part of sidelink control information (SCI) channel encoded in a physical sidelink control channel (PSCCH) and/or a physical sidelink shared channel (PSSCH).

5. The method of claim 1, wherein the one or more assistance information is signaled by the UE to the peer UE via a PC5-radio resource configuration (RRC) information and/or a medium access control-control element (MAC-CE) information.

6. The method of claim 1, wherein the one or more assistance information comprises at least one of following information:
a starting and/or a slot offset from a reference time or slot, wherein the starting and/or the slot offset is a slot in which the assistance information is transmitted or an offset to a sidelink system frame number (SFN);
a duration timer used to indicate a time length for a sidelink suspended/discontinued reception;
a source identifier (ID) and/or a destination ID used to identify the SL unicast communication link for which the sidelink suspended/discontinued reception applies; or
a cast type indicator used to indicate a unicast.

7. The method of claim 1, wherein the one or more assistance information indicated in a SCI is used for sidelink unicast reception with a receive beamforming by the peer UE.

8. The method of claim 1, wherein by providing the one or more assistance information to the peer UE, the peer UE is not be required to apply a directional receive beam and/or beamforming associated with the sidelink unicast communication link other than the another timing/slot and/or the another duration.

9. The method of claim 7, wherein the one or more assistance information comprises at least one of following information:
a time resource assignment for one transport block (TB) and/or a hybrid automatic repeat request (HARQ) process number;
an additional time resource assignment for another TB and/or another HARQ process number;
one or more HARQ process numbers for one or more TBs;
one or more resource reservation periods for one or more TBs and/or one or more HARQ process numbers;
a source ID and/or a destination ID used to identify the sidelink unicast communication link for which a sidelink suspended/discontinued reception applies; or
a cast type indicator used to indicate a unicast.

10. The method of claim 1, further comprising:
requesting the peer UE during a UE autonomous resource allocation procedure to exclude candidate resources based on a discontinued reception time provided in the one or more assistance information when the UE is not expected to receive a sidelink unicast transmission.

11. The method of claim 1, further comprising:
requesting the peer UE during a UE autonomous resource allocation procedure to exclude candidate resources based on the time resource assignments, the one or more resource reservation periods and/or a timing/slot indicated in the SCI for the sidelink unicast transmission by the UE.

12. A user equipment (UE), comprising:
a memory;
a transceiver; and
a processor coupled to the memory and the transceiver;
wherein the UE is configured to perform:
providing one or more assistance information to a peer UE in a sidelink unicast communication link; and
determining a timing/slot and/or a duration and a type of receive beam to use for a sidelink reception in a sidelink resource pool; and/or indicating the peer UE for determination of another timing/slot and/or another duration and another type of receive beam to use for the sidelink reception in the sidelink resource pool.

13. The UE of claim 12, wherein the UE in the sidelink unicast communication link is configured to indicate or configure the peer UE the timing/slot and/or the duration associated with a discontinued reception time in which the UE does not expect to receive a sidelink unicast transmission from the peer UE.

14. The UE of claim 12, wherein by providing the one or more assistance information to the peer UE, the UE is not be required to apply a directional receive beam and/or beamforming associated with the sidelink unicast communication link during the discontinued reception time.

15. The UE of claim 12, wherein the one or more assistance information is transmitted as a part of sidelink control information (SCI) channel encoded in a physical sidelink control channel (PSCCH) and/or a physical sidelink shared channel (PSSCH).

16. The UE of claim 12, wherein the one or more assistance information is signaled by the UE to the peer UE via a PC5-radio resource configuration (RRC) information and/or a medium access control-control element (MAC-CE) information.

17. A chip, including:
a processor, configured to call and run a computer program stored in a memory, to cause a device in which the chip is installed to execute:
providing one or more assistance information to a peer UE in a sidelink unicast communication link; and
determining a timing/slot and/or a duration and a type of receive beam to use for a sidelink reception in a sidelink resource pool; and/or indicating the peer UE for determination of another timing/slot and/or another duration and another type of receive beam to use for the sidelink reception in the sidelink resource pool.

18. The chip of claim 17, wherein the one or more assistance information comprises at least one of following information:
a starting and/or a slot offset from a reference time or slot, wherein the starting and/or the slot offset is a slot in which the assistance information is transmitted or an offset to a sidelink system frame number (SFN);
a duration timer used to indicate a time length for a sidelink suspended/discontinued reception;
a source identifier (ID) and/or a destination ID used to identify the SL unicast communication link for which the sidelink suspended/discontinued reception applies; or
a cast type indicator used to indicate a unicast.

19. The chip of claim 17, wherein the one or more assistance information indicated in a SCI is used for sidelink unicast reception with a receive beamforming by the peer UE.

20. The chip of claim 17, wherein by providing the one or more assistance information to the peer UE, the peer UE is not be required to apply a directional receive beam and/or beamforming associated with the sidelink unicast communication link other than the another timing/slot and/or the another duration.
